(19) United States
(12) Patent Application Publication
(10) Pub. No.: US 2026/0095799 A1
(43) Pub. Date: Apr. 2, 2026

(54) CARRIER AGGREGATION RADIO RESOURCE MANAGEMENT ENHANCEMENT

(71) Applicant: Apple Inc., Cupertino, CA (US)

(72) Inventors: Jie Cui, San Jose, CA (US); Dawei Zhang, Saratoga, CA (US); Hong He, San Jose, CA (US); Qiming Li, Beijing (CN); Xiang Chen, Campbell, CA (US); Yang Tang, San Jose, CA (US)

(73) Assignee: Apple Inc., Cupertino, CA (US)

(21) Appl. No.: 19/312,142

(22) Filed: Aug. 27, 2025

Related U.S. Application Data
(60) Provisional application No. 63/700,556, filed on Sep. 27, 2024.

(51) Int. Cl. H04W 24/10; H04B 17/373; H04W 16/28; H04W 36/00

(52) U.S. Cl. CPC H04W 24/10; H04B 17/373; H04W 16/28; H04W 36/0058

(57) ABSTRACT

The present application relates to devices and components including apparatus, systems, and methods for carrier aggregation (CA) radio resource management (RRM) measurement in wireless communication systems.

### CROSS-REFERENCES TO RELATED APPLICATIONS

This application claims the benefit to U.S. Provisional Application No. 63/700,556, filed Sep. 27, 2024, entitled “Carrier Aggregation Radio Resource Management Enhancement,” the disclosure which is incorporated by reference in its entirety and for all purposes.

### TECHNICAL FIELD

The present application relates to the field of wireless technologies and, in particular, to measurement enhancement for carrier aggregation.

### BACKGROUND

Third Generation Partnership Project (3GPP) networks provide for a user equipment (UE) to be configured to utilize multiple component carriers (CCs). A searcher resource may be shared among the CCs assigned to the UE. The UE utilizes the searcher resource to cycle through measuring CCs.

### BRIEF DESCRIPTION OF THE DRAWINGS

FIG. 1 illustrates a network environment in accordance with some embodiments.

FIG. 2 illustrates a user equipment (UE) in accordance with some embodiments.

FIG. 3 illustrates a network device in accordance with some embodiments.

FIG. 4 illustrates a table of example CSSF_{outside_gap,i} scaling factors for standalone (SA) mode in accordance with some embodiments.

FIG. 5 illustrates a table of example measurement periods for intrafrequency measurements without gaps (Frequency FR2) in accordance with some embodiments.

FIG. 6 illustrates a first portion of an artificial intelligence (AI)/machine language (ML) based measurement representation in accordance with some embodiments.

FIG. 7 illustrates a second portion of the AI/ML based measurement representation in accordance with some embodiments.

FIG. 8 illustrates an example fingerprint based measurement result prediction arrangement in accordance with some embodiments.

FIG. 9 illustrates another example fingerprint based measurement result prediction arrangement in accordance with some embodiments.

FIG. 10 illustrates another example fingerprint based measurement result prediction arrangement in accordance with some embodiments.

FIG. 11 illustrates an example procedure for predicting a quality of a carrier in accordance with some embodiments.

FIG. 12 illustrates an example procedure for determining additional radio frequency (RF) pattern information of a set of RF patterns in accordance with some embodiments.

FIG. 13 illustrates an example procedure for performing measurements of a single RF pattern of a set of RF patterns in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “based at least in part on” as used herein may indicate that an item is based solely on another item and/or an item is based on another item and one or more additional items. For example, item 1 being determined based at least in part on item 2 may indicate that item 1 is determined based solely on item 2 and/or is determined based on item 2 and one or more other items in embodiments.

The term “AI/ML model” as used herein may indicate an artificial intelligence (AI) model, a machine learning (ML) model, or a model for both AI and ML.

Approaches described herein provide for carrier aggregation (CA) radio resource management (RRM) measurement enhancements. The approaches may reduce the number of measurements and/or the number of component carriers (CCs) to be performed by a user equipment (UE). Each measurement and/or CC to be measured may cause delay, which can cause issues if the delay is too long. The approaches presented herein assist in making sure the delay is not too long to cause issues.

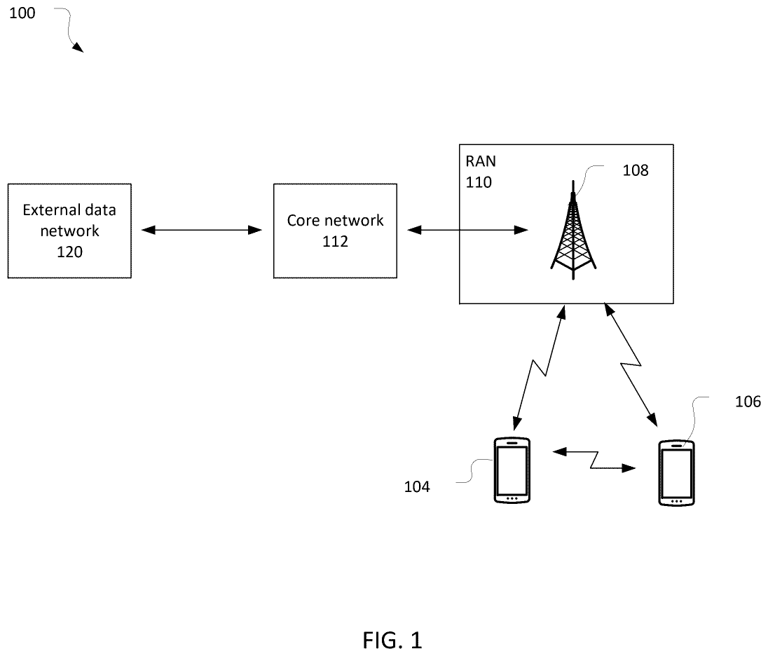

FIG. 1 illustrates a network environment 100 in accordance with some embodiments. The network environment 100 may include a user equipment (UE) 104 communicatively coupled with a base station 108 of a radio access network (RAN) 110. The UE 104 and the base station 108 may communicate over air interfaces compatible with 3GPP TSs such as those that define a Fifth Generation (5G) new radio (NR) system or a later system. The base station 108 may provide user plane and control plane protocol terminations toward the UE 104.

In some embodiments, the UE 104 and base station 108 may establish data radio bearers (DRBs) to support transmission of data over a wireless link between the two nodes. In one example, these DRBs may be used for traffic from extended reality (XR) applications that contains a large amount of data conveying real and virtual images and audio for presentation to a user.

The network environment 100 may further include a core network 112. For example, the core network 112 may comprise a 5^{th} Generation Core network (5GC) or later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions.

In some embodiments, the network environment 100 may also include UE 106. The UE 106 may be coupled with the UE 104 via a sidelink interface. In some embodiments, the UE 106 may act as a relay node to communicatively couple the UE 104 to the RAN 110. In other embodiments, the UE 106 and the UE 104 may represent end nodes of a communication link. For example, the UEs 104 and 106 may exchange data with one another.

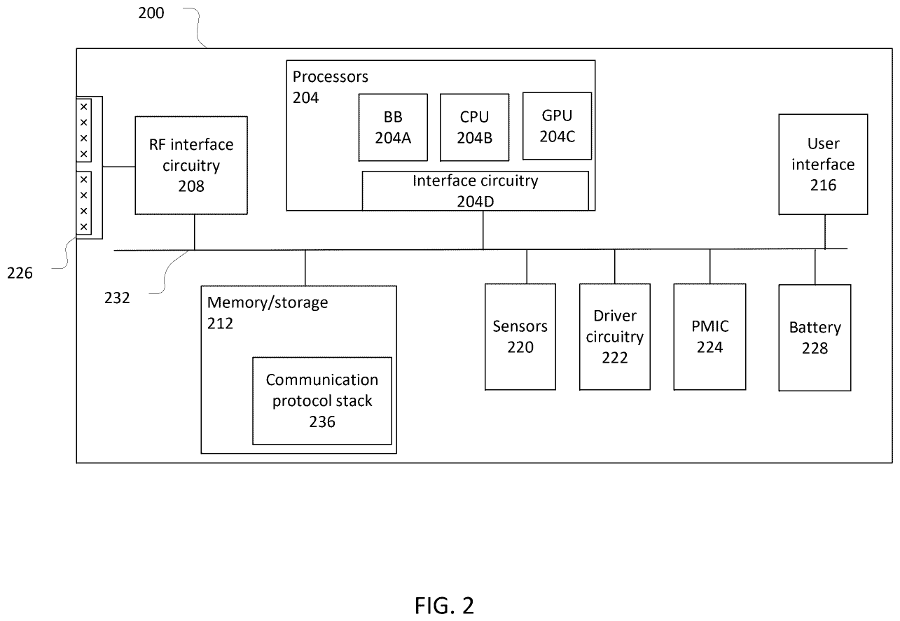

FIG. 2 illustrates a UE 200 in accordance with some embodiments. The UE 200 may be similar to and substantially interchangeable with UE 104 or 106.

The UE 200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 200 may include processors 204, RF interface circuitry 208, memory/storage 212, user interface 216, sensors 220, driver circuitry 222, power management integrated circuit (PMIC) 224, antenna 226, and battery 228. The components of the UE 200 may be implemented as integrated circuits (ICs), portions thereof, discrete electronic devices, or other modules, logic, hardware, software, firmware, or a combination thereof. In some embodiments, the processor 204 may include RF interface circuitry 208. The block diagram of FIG. 2 is intended to show a high-level view of some of the components of the UE 200. However, some of the components shown may be omitted, additional components may be present, and different arrangement of the components shown may occur in other implementations.

The components of the UE 200 may be coupled with various other components over one or more interconnects 232, which may represent any type of interface, input/output, bus (local, system, or expansion), transmission line, trace, or optical connection that allows various circuit components (on common or different chips or chipsets) to interact with one another.

The processors 204 may include processor circuitry such as, for example, baseband processor circuitry (BB) 204A, central processor unit circuitry (CPU) 204B, and graphics processor unit circuitry (GPU) 204C. The processors 204 may include any type of circuitry or processor circuitry that executes or otherwise operates computer-executable instructions, such as program code, software modules, or functional processes from memory/storage 212 to cause the UE 200 to perform carrier aggregation (CA) radio resource management (RRM) measurement operations as described herein. The processors 204 may also include interface circuitry 204D to communicatively couple the processor circuitry with one or more other components of the UE 200.

In some embodiments, the baseband processor circuitry 204A may access a communication protocol stack 236 in the memory/storage 212 to communicate over a 3GPP compatible network. In general, the baseband processor circuitry 204A may access the communication protocol stack 236 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 208.

The baseband processor circuitry 204A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 212 may include one or more non-transitory, computer-readable media that includes instructions (for example, communication protocol stack 236) that may be executed by one or more of the processors 204 to cause the UE 200 to perform various carrier aggregation (CA) radio resource management (RRM) measurement operations described herein.

The memory/storage 212 includes any type of volatile or non-volatile memory that may be distributed throughout the UE 200. In some embodiments, some of the memory/storage 212 may be located on the processors 204 themselves (for example, memory/storage 212 may be part of a chipset that corresponds to the baseband processor circuitry 204A), while other memory/storage 212 is external to the processors 204 but accessible thereto via a memory interface. The memory/storage 212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 208 may include transceiver circuitry and a radio frequency front module (RFEM) that allows the UE 200 to communicate with other devices over a radio access network. The RF interface circuitry 208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 226 and proceed to filter and amplify (with a low-noise amplifier) the signal. The signal may be provided to a receiver of the transceiver that down-converts the RF signal into a baseband signal that is provided to the baseband processor of the processors 204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 226.

In various embodiments, the RF interface circuitry 208 may be configured to transmit/receive signals in a manner compatible with NR access technologies.

The antenna 226 may include antenna elements to convert electrical signals into radio waves to travel through the air and to convert received radio waves into electrical signals. The antenna elements may be arranged into one or more antenna panels. The antenna 226 may have antenna panels that are omnidirectional, directional, or a combination thereof to enable beamforming and multiple input, multiple output communications. The antenna 226 may include microstrip antennas, printed antennas fabricated on the surface of one or more printed circuit boards, patch antennas, or phased array antennas. The antenna 226 may have one or more panels designed for specific frequency bands including bands in FR1 or FR2.

The user interface 216 includes various input/output (I/O) devices designed to enable user interaction with the UE 200. The user interface 216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 200.

The sensors 220 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 222 may include software and hardware elements that operate to control particular devices that are embedded in the UE 200, attached to the UE 200, or otherwise communicatively coupled with the UE 200. The driver circuitry 222 may include individual drivers allowing other components to interact with or control various input/output (I/O) devices that may be present within, or connected to, the UE 200. For example, driver circuitry 222 may include a display driver to control and allow access to a display device, a touchscreen driver to control and allow access to a touchscreen interface, sensor drivers to obtain sensor readings of sensors 220 and control and allow access to sensors 220, drivers to obtain actuator positions of electro-mechanic components or control and allow access to the electro-mechanic components, a camera driver to control and allow access to an embedded image capture device, audio drivers to control and allow access to one or more audio devices.

The PMIC 224 may manage power provided to various components of the UE 200. In particular, with respect to the processors 204, the PMIC 224 may control power-source selection, voltage scaling, battery charging, or DC-to-DC conversion.

A battery 228 may power the UE 200, although in some examples the UE 200 may be mounted deployed in a fixed location and may have a power supply coupled to an electrical grid. The battery 228 may be a lithium ion battery, a metal-air battery, such as a zinc-air battery, an aluminum-air battery, a lithium-air battery, and the like. In some implementations, such as in vehicle-based applications, the battery 228 may be a typical lead-acid automotive battery.

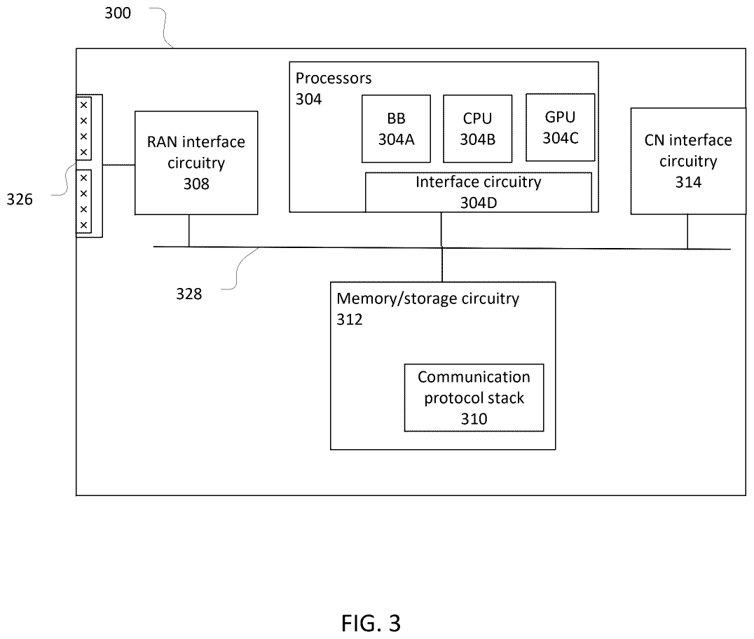

FIG. 3 illustrates a network device 300 in accordance with some embodiments. The network device 300 may be similar to and substantially interchangeable with base station 108 or a device of the core network 112 or external data network 120.

The network device 300 may include processors 304, RF interface circuitry 308 (if implemented as a base station), core network (CN) interface circuitry 314, memory/storage circuitry 312, and antenna structure 326.

The components of the network device 300 may be coupled with various other components over one or more interconnects 328.

The processors 304, RF interface circuitry 308, memory/storage circuitry 312 (including communication protocol stack 310), antenna structure 326, and interconnects 328 may be similar to like-named elements shown and described with respect to FIG. 2.

The processors 304 may include processor circuitry such as, for example, baseband processor circuitry (BB) 304A, central processor unit circuitry (CPU) 304B, and graphics processor unit circuitry (GPU) 304C. The processors 304 may include any type of circuitry or processor circuitry that executes or otherwise operates computer-executable instructions, such as program code, software modules, or functional processes from memory/storage circuitry 312 to cause the network device 300 to perform operations described herein. The processors 304 may also include interface circuitry 304D to communicatively couple the processor circuitry with one or more other components of the network device 300.

The CN interface circuitry 314 may provide connectivity to a core network, for example, a 5th Generation Core network (5GC) using a 5GC-compatible network interface protocol such as carrier Ethernet protocols, or some other suitable protocol. Network connectivity may be provided to/from the network device 300 via a fiber optic or wireless backhaul. The CN interface circuitry 314 may include one or more dedicated processors or FPGAs to communicate using one or more of the aforementioned protocols. In some implementations, the CN interface circuitry 314 may include multiple controllers to provide connectivity to other networks using the same or different protocols.

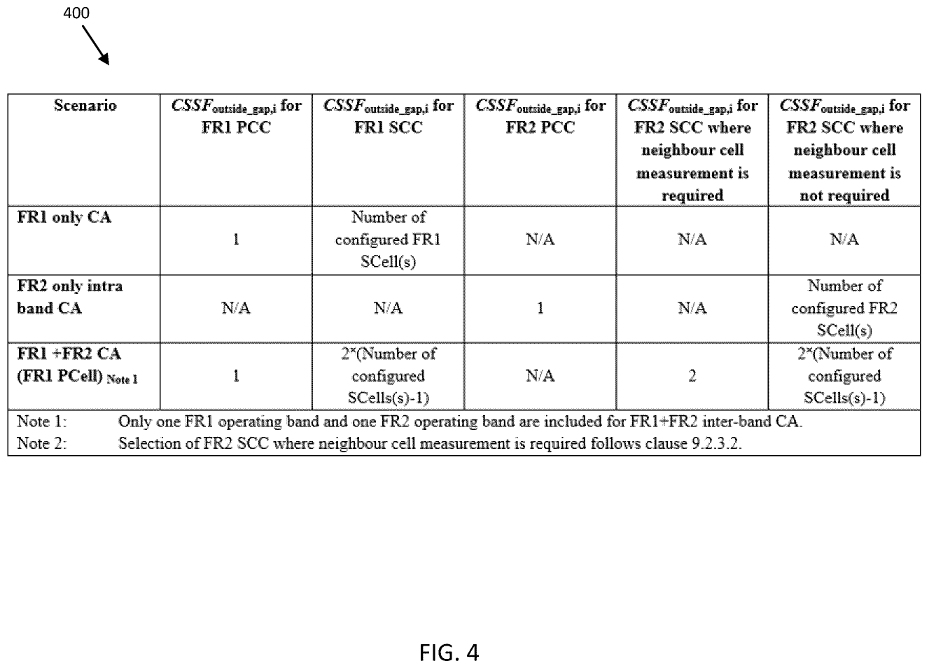

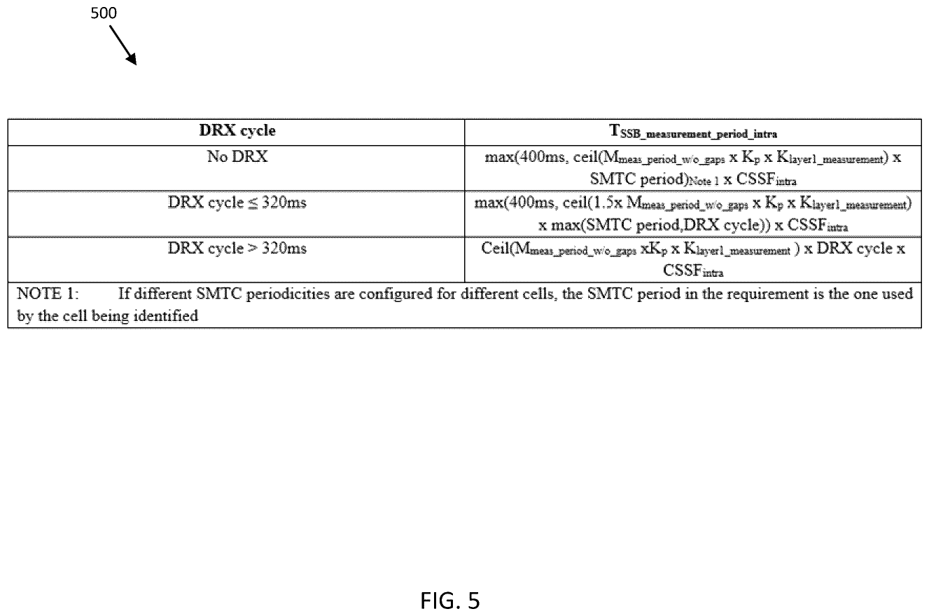

Approaches for radio resource management (RRM) measurement enhancement for carrier aggregation (CA) in sixth generation (6G) are described herein. In fifth generation (5G), multiple serving component carriers (CCs) could be configured to a user equipment (UE) for aggregation. It could be, for example, up to 15 CCs in frequency range 2 (FR2) non-contiguous CA (CA_n261(A-7O)). With big number of serving CC numbers in CA, the searcher resource (2 searchers in near radio (NR)) shall be shared among those serving CCs. The carrier-specific scaling factor (CSSF) in technical specification (TS) 38.133 (3^{rd} Generation Partnership Project; Technical Specification Group Radio Access Network; NR; Requirements for support of radio resource management (Release 18). (2024). 3GPP TS 38.133, 18.6.0) for FR2 CA and serving CC measurement delay is specified as in FIG. 4 and FIG. 5.

FIG. 4 illustrates a table 400 of example CSSF_{outside_gap,i} scaling factors for standalone (SA) mode in accordance with some embodiments. For example, the table 400 illustrates CSSF information for outside of measurement gaps. A UE implementing the illustrated CSSF_{outside_gap,i} scaling factors may be configured without measurement gaps.

FIG. 5 illustrates a table 500 of example measurement periods for intrafrequency measurements without gaps (Frequency FR2) in accordance with some embodiments. For example, the table 500 illustrates measurement periods for a UE configured without measurement gaps.

If no discontinuous reception (DRX) is used, and no measurement gap (MG) is configured, and no radio link monitoring (RLM)/beam-management is colliding with synchronization signal block-based radio resource management measurement timing configuration (SMTC), then the delay is 24*1*1*SMTC*14=13.44 seconds(s) for SMTC=40 millisecond (ms) case. This is much longer than 5 s in the following definition as “detectable.” This example is for power class (PC)1/2/3 UE. If PC4 is considered this delay will be much longer. It was also specified that, in handover (HO), in the interruption requirement a cell is known if it has been meeting the relevant cell identification requirement during the last 5 seconds otherwise it is unknown.

A cell is detectable only if at least one synchronization signal blocks (SSBs) measured from the Cell being configured remains detectable during the time period T_{identify_intra_without_index} or T_{identify_intra_with_index} as defined in clause 9.2.5.1 or clause 9.2.6.2 of TS 38.133. If a cell which has been detectable at least for the time period T_{identify intra without index} or T_{identify} intra with index defined in clause 9.2.5.1 or clause 9.2.6.2 becomes undetectable for a period less than or equal to 5 seconds and then the cell becomes detectable again with the same spatial reception parameter and triggers an event, the event triggered measurement reporting delay shall be less than T_{SSB_measurement_period_intra} provided the timing to that cell has not changed more than ±3200 T_{c} while the measurement gap has not been available and layer 3 (L3) filtering has not been used. When L3 filtering is used, an additional delay can be expected.

Secondary cell (SCell) in frequency range 1 (FRl) is known if it has been meeting the following conditions: During the period equal to max(5*measCycleSCell, 5*DRX cycles) for FRl before the reception of the SCell activation command the UE has sent a valid measurement report for the SCell being activated and the SSB measured remains detectable according to the cell identification conditions specified in clause 9.2 and 9.3 of TS 38.133; and the SSB measured during the period equal to max(5*measCycleSCell, 5*DRX cycles) also remains detectable during the SCell activation delay according to the cell identification conditions specified in clause 9.2 and 9.3. Otherwise SCell in FRl is unknown.

For the first SCell activation in FR2 bands, the SCell is known if it has been meeting the following conditions: During the period equal to 4 s for UE supporting power class 1/5 and 3 s for UE supporting power class 2/3/4 before UE receives the last activation command for physical downlink control channel (PDCCH) transmission configuration indication (TCI), physical downlink shared channel (PDSCH) TCI (when applicable) and semi-persistent channel state information reference signal (CSI-RS) for channel quality indicator (CQI) reporting (when applicable), the UE has sent a valid layer 3 (L3)-reference signal received power (RSRP) measurement report with SSB index, and SCell activation command is received after L3-RSRP reporting and no later than the time when UE receives medium access control (MAC)-control element (CE) command for TCI activation; and during the period from L3-RSRP reporting to the valid CQI reporting, the reported SSBs with indexes remain detectable according to the cell identification conditions specified in clauses 9.2 and 9.3, and the TCI state is selected based on one of the latest reported SSB indexes.

Otherwise, the first SCell in FR2 band is unknown. The requirement for unknown SCell applies provided that the activation commands for PDCCH TCI, PDSCH TCI (when applicable), semi-persistent CSI-RS for CQI reporting (when applicable), and configuration message for TCI of periodic CSI-RS for CQI reporting (when applicable) are based on the latest valid Ll-RSRP reporting.

Longer measurement delay will cause mobility impacts and UE power consuming, as well as the scheduling restriction.

For a first approach (which may be referred to as approach 1), artificial intelligence (AI)/machine language (ML) based measurement result prediction of secondary component carrier (SCC) and inter-frequency cells may be implemented. For example, a universal AI/ML model may be used to cover intra-frequency/inter-frequency RRM measurement with/without reception (Rx) beam (hold on). A UE may be configured with the AI/ML model for predicting measurement results for SCC and inter-frequency cells. The channel condition might be different between serving and neighbor cell. It is hard to know if the channel response is same and therefore it is hard to say serving cell model can be used for neighbor cells.

For a second approach (which may be referred to as approach 2), radio frequency (RF) finger print based measurement result prediction may be implemented. The approach can be applied SCell operation (including addition and/or activation), primary secondary cell (PSCell) operation (including addition and/or activation), and/or inter-frequency/intra-frequency/inter-radio access technology (RAT) mobility. The approach to maintain the RF fingerprint database may include minimum drive test (MDT) based UE reporting in the coverage. The network may configure such reporting for the UE that supports this feature. When a UE has CA/dual connectivity (DC) or intra-frequency/inter-frequency/inter-RAT measurement results, the UE may report these results to the network (NW), with or without location information (optional).

Herein disclosed are potential measurement approaches for CA in 6G. UE side models are used as examples throughout this disclosure to illustrate the potential measurement approaches.

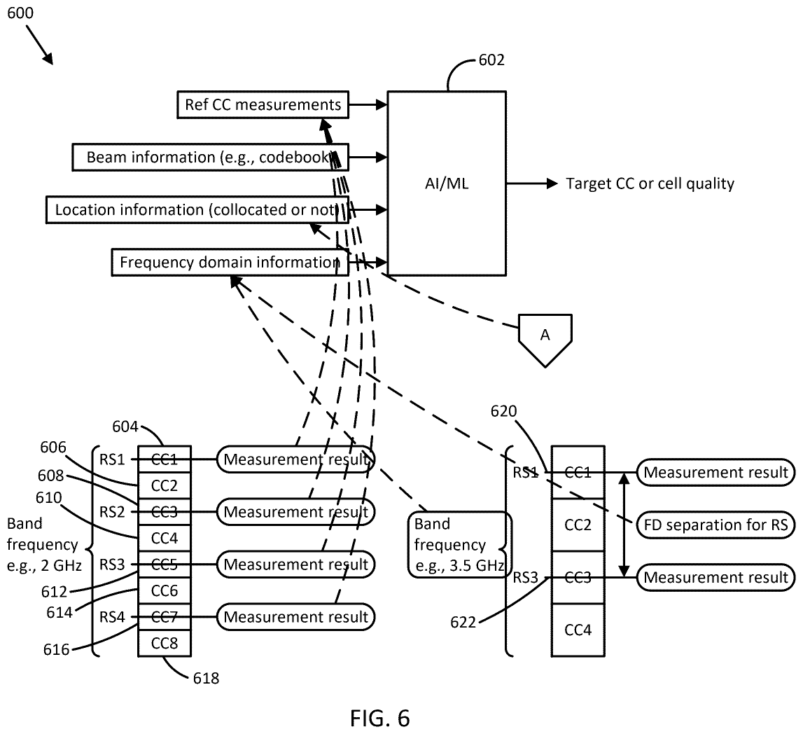

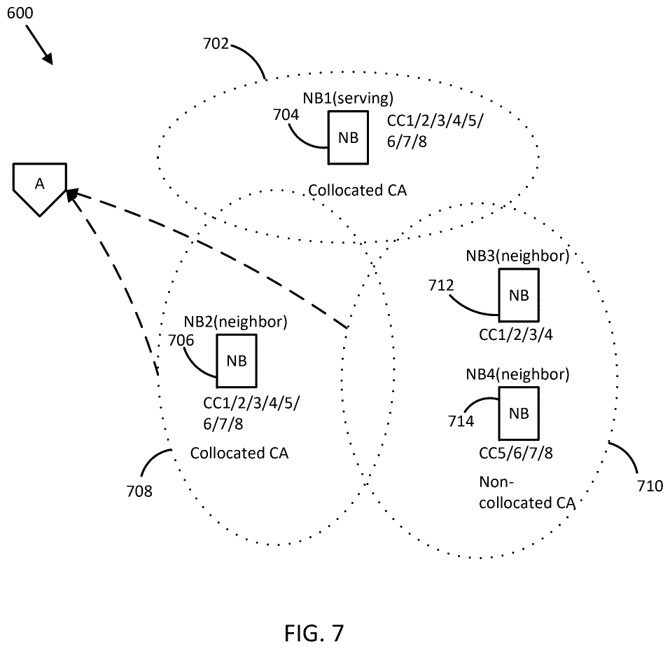

In a first option (which may be referred to as option 1), AI/ML based measurement result prediction of SCC and inter-frequency cells may be implemented. For example, a universal AI/ML model may cover intra-frequency/inter-frequency RRM measurement with/without Rx beam. FIG. 6 illustrates a first portion of an AI/ML based measurement representation 600 in accordance with some embodiments. FIG. 7 illustrates a second portion of the AI/ML based measurement representation 600 in accordance with some embodiments. The representation 600 illustrates example AI/ML based measurement result prediction of SCC and inter-frequency cells in accordance with some embodiments.

For the first option, the network may configure measurement on reference carriers of a same cell coverage instead of all carriers. For example, a first cell 702 coverage may have a first base station 704 that has CC1/2/3/4/5/6/7/8. For the first option, the network (such as via the first base station 704) may configure a UE with reference carriers of CC1/3/5/8 for performing measurements. Multiple reference carriers can give the AI/ML model more inputs to accurately predict the other carriers'quality of the same cell coverage.

For example, the network may configure the UE to perform measurements of one or more CCs hosted by the first base station 704, the CCs configured to be measured referred to as reference carriers. The more reference carriers that the UE is configured to measure, the more accurate the prediction of the quality of other CCs. The UE may perform measurements of the reference carriers. The UE may be configured with an AI/ML model 602. The UE may utilize the AI/ML model 602 with the measurements from the RF carriers to predict the quality of one or more other CCs and/or cells. In other embodiments, the network (such as the first base station 704) may implement the AI/ML model 602 and the UE may transmit the measurement results of the reference carriers to the network (such as via the first base station 704) for use in the AI/ML model 602 for predicting the quality of one or more other CCs and/or cells.

In the illustrated example, a base station may host a set of carriers including a first CC 604, a second CC 606, a third CC 608, a fourth CC 610, a fifth CC 612, a sixth CC 614, a seventh CC 616, and an eighth CC 618. The UE may be configured to treat the first CC 604, the third CC 608, the fifth CC 612, and the seventh CC 616 as reference carriers. The UE may be configured to perform measurement of the reference carriers, thereby producing measurement results from the first CC 604, the third CC 608, the fifth CC 612, and the seventh CC 616. The UE may utilize the measurement results in implementing the AI/ML model 602 for predicting quality values for the other CCs that were not measured.

Network may also provide beam information (e.g., code book information) of different cells/nodeBs (NBs) to the UE. For example, the CCs on a second base station 706 (which may be referred to as NB2) may have the same beamforming codebook as the current serving, which is the first base station 704 (which may be referred to as NB1) in the illustrated example. The UE can use the beam information of different base stations (which may be referred to as NBs) to predict the beam measurement results of different target cells/NBs based on different AI/ML models.

For example, the network may provide (such as via the first base station 704) beam information for different cells and/or base stations to the UE. In the illustrated representation 600, the beam information may include beam information for the first cell 702, the first base station 704, the second base station 706, a second cell 708, a third cell 710, a third base station 712, and/or a fourth base station 714. The UE may utilize the beam information in the AI/ML model 602 for predicting quality of other CCs and/or cells, and/or may utilize the beam information to determine which AI/ML model should be used for predicting quality of another CC and/or cell. In some embodiments, the network (such as the first base station 704) may implement the AI/ML model, and the network may utilize the beam information for predicting quality of CCs and/or cells, and/or determining which AI/ML model is to be utilized for predicting quality of CCs and/or cells.

The network may also indicate the collocation information of target neighbor base stations (NBs)/cells to the UE. For example, the CCs on the second base station 706 (NB2) are collocated, but the CCs on the third base station 712 (NB3) and the fourth base station 714 (NB4) are not collocated in the illustrated embodiment. The collocation information may differentiate the AI/ML models for measurement prediction. For example, collocated CCs may use the model different from non-collocated CCs.

In some embodiments, the UE may be configured with different AI/ML models depending on whether CCs for a target base station and/or cell are collocated or not. Different AI/ML models may be trained for base stations/cells with collocated CCs and base stations/cells with non-collocated CCs. The UE may receive the collocation information from the network and may determine which of the AI/ML models is to be used for predicting the quality of a CC based on the collocation information. Accordingly, the UE may implement a first AI/ML model for the second base station 706 with collocated CCs and a second AI/ML model for the third base station 712 and the fourth base station 714 with non-collocated CCs in the illustrated embodiment. The UE may determine which AI/ML model to utilize based collocation information for the second base station 706, the third base station 712, and the fourth base station 714 received from the network.

UE may also use the frequency domain (FD) separation among CCs to predict the measurement results of a specific CC. For example, FD separation between 2 reference CCs (CC1 and CC3) can be also input to the AI/ML model to predict the CC2 measurement quality. If the separation is too big, the channel conditions might be quite different and the AI/ML method may be not applicable.

For example, the UE may be configured for performing measurements of a first reference carrier 620 and a second reference carrier 622 for use in predicting quality values of other CCs via an AI/ML model. The UE may determine an FD separation between the first reference carrier 620 and the second reference carrier 622. The UE may then utilize the FD separation to determine whether the AI/ML model can be utilized for predicting other CCs and/or in determining the quality values of the other CCs.

One or more AI/ML models may be trained using training reference CC measurements, training beam information, training location information, and/or training frequency domain information. Training may include adjusting weightings of inputs to the AI/ML models and/or adjusting threshold values related to the AI/ML models to achieve a certain accuracy of the AI/ML model. In some embodiments, a UE may be configured to measure all of the CCs within a set of CCs hosted by a base station in a training stage. The UE may then utilize a portion of the resulting measurements in an AI/ML model for predicting the values of the other portion of the resulting measurements. The AI/ML model may be trained with the training data until the predictions are within an acceptable error value. The UE may then utilize the trained AI/ML model during normal operation to predict quality of CCs. In some instances, the UE may be configured to retrain the AI/ML model when triggered. In other embodiments, the UE may be configured with a pretrained AI/ML model that has been previously trained.

While the illustrated example shows all of the reference CC measurements, beam information, location information, and FD information being utilized by the AI/ML model 602 for predicting target CCs or cell quality, it should be understood that some portion of the inputs can be utilized by AI/ML models for predicting target CCs and/or cell quality in other embodiments. For example, a UE may be configured to utilize one or more of the reference CC measurements, beam information, location information, and/or FD information in an AI/ML model for predicting target CCs and/or cell quality in other embodiments.

In a second option (which may be referred to as option 2), RF finger print based measurement result prediction may be implemented. Radio Frequency Pattern Matching (RFPM) or fingerprint sometimes referred to as RF fingerprinting, is a general class of positioning techniques by which a set of RF measurements, made either by the UE or the base station (such as an evolved NodeB (eNB)), is compared against a reference set of values in order to estimate the UE location. Such finger print can also be used to decide UE's status for RRM decision, such as SCell operation addition/activation, PSCell operation addition/activation, and/or inter-frequency/intra-frequency/inter-RAT mobility.

Types of finger prints may include signal strength measurements, timing measurements, and beam measurements. Signal strength measurements may include RSRP, reference signal received quality (RSRQ), signal-to-interference-plus noise ratio (SINR), and/or received signal strength indicator (RSSI). Timing measurements may include absolute arrival timing for target cells, received timing difference among different target cells, and/or absolute round trip time between UE and target cells.

Beam measurements may include the transmission (Tx) beam indexes (of different cells), the reception (Rx) beam indexed for receiving strongest signals from different target cells, and/or Tx and Rx beam pair for receiving strongest signals from different target cells. The beam pair can be # M Tx +# N Rx for cell S, which means the best beam pair to receive signal from target cell S is by using Tx beam # M and Rx beam # N. A challenge of beam pair is that it can be easily impacted by UE rotation.

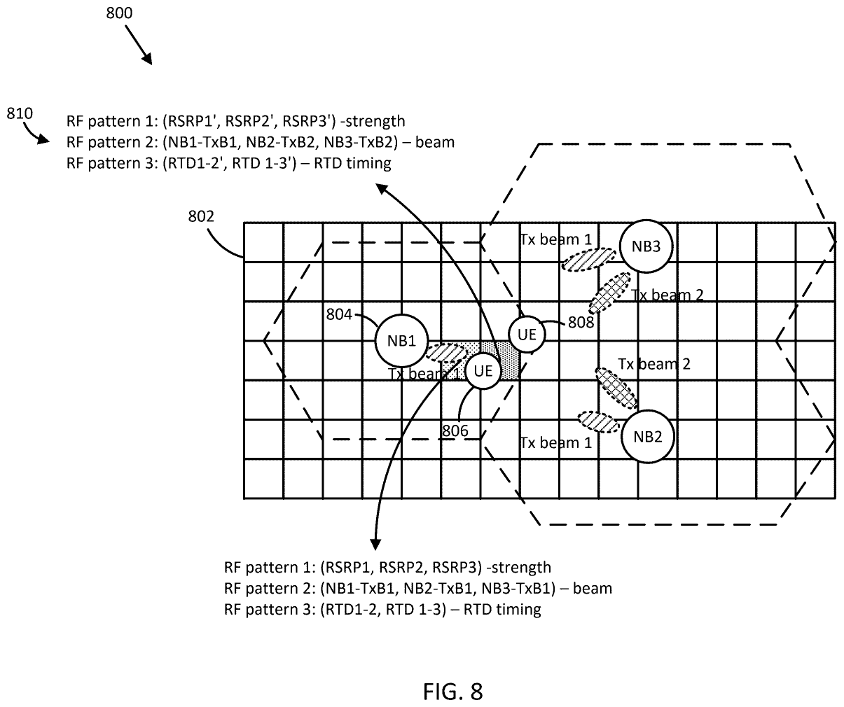

FIG. 8 illustrates an example fingerprint based measurement result prediction arrangement 800 in accordance with some embodiments. The RF pattern or fingerprint may be used to determine a virtual UE location/grid (not exactly geographic location), and such pattern can derive the other SCC and inter-frequency measurement result on this grid. For example, a grid pattern may be assigned over an area of interest, such as the grid 802. The use of the RF pattern or fingerprint can avoid the Tx beam sweeping to serve the UE on this grid.

The network may configure some UEs to measure and report the full sets of the RF patterns or fingerprint, and create the relation among these RF patterns. For example, the network may configure (via a first base station 804) a first UE 806 and/or a second UE 808 to report a full set of RF patterns or fingerprint. For those UEs configured with the full sets of fingerprint measurement, on a specific spot, UE may report signal strength, relative time difference (RTD), and/or beam information to the network. The NW can store such relation among signal strength, RTD, and/or beam information into the database. The UE may report such relations among 3 measurement metrics to NW. The following RF patterns 1/2/3 may be linked. RF pattern 1: (RSRP1′, RSRP2′, RSRP3′)—strength. RF pattern 2: (NB1-TxB1, NB2-TxB2, NB3-TxB2)—beam. RF pattern 3: (RTD1-2′, RTD 1-3′)—RTD timing. For example, a UE may provide a report 810 to the network that includes information for RF patterns to be linked in a set of RF patterns. The report may include values for the RF pattern 1, RF pattern 2, and RF pattern 3, as indicated above.

For the other UEs that access the network, the network may configure such UEs to measure/report only part of the RF patterns within the set and then match the reported results in the database. For example, the UE may measure RF pattern 2 characteristics of Tx beams and find the best Tx beams of NB1/2/3. After the UE reports the best Tx beam index, network can know the signal strength and RTD information of this UE and can further decide the mobility for this UE.

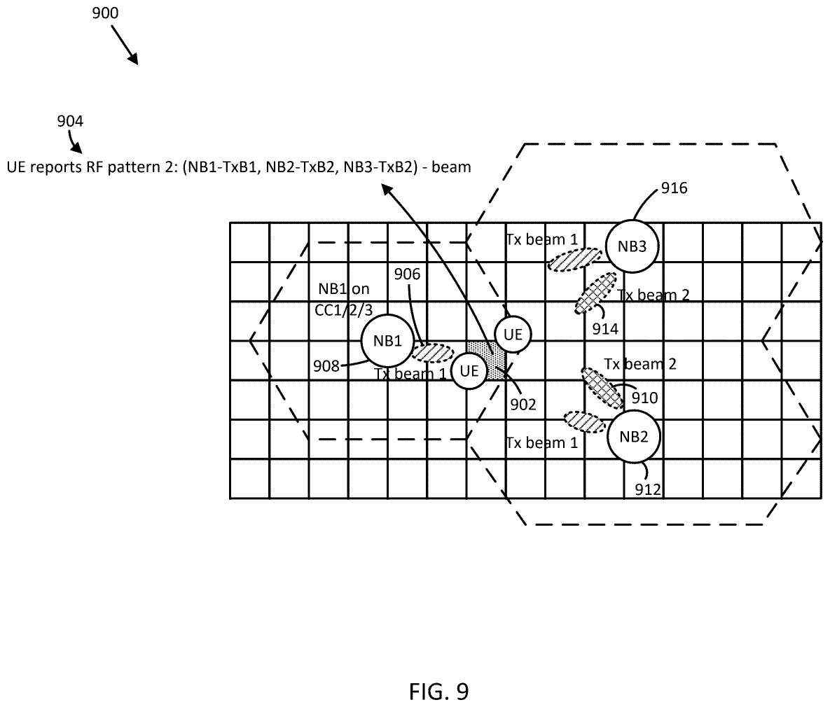

FIG. 9 illustrates another example fingerprint based measurement result prediction arrangement 900 in accordance with some embodiments. A UE may perform measurements for RF pattern 2 for a grid position 902. The UE may generate and transmit a report 904 that includes measurement information for the RF pattern 2 to the network. In the illustrated embodiment, the measurement information may include NB1-TxB1 (that indicates a first beam 906 of a first base station 908), NB2-TxB2 (that indicates a second beam 910 of a second base station 912), and NB3-TxB2 (that indicates a second beam 914 of a third base station 916) indicating the best Tx beams for the UE. The network may determine the signal strength information and/or the RTD information for the UE by matching the reported RF pattern 2 information from the UE with stored pattern 2 data, and then determining stored pattern 1 data and pattern 3 data corresponding to the stored pattern 2 data. On this grid, carriers 1/2/3 may have good coverage or quality based on previous report of beam index and/or signal strength of different carriers.

The use case from network after UE reporting one pattern of the measurement metrics may include supporting SCell operation and/or PSCell operation. For support SCell operation, the NW can decide to perform SCell addition/activation after UE reports one pattern of the measurements, since network can know the CC 1/2/3 quality is good on this grid. For PSCell operation, the NW can decide to perform PSCell addition/activation after UE reports one pattern of the measurements, like SCell operation.

In the arrangement, the UE may not have to measure the RSRP/RSRQ of all CCs on this grid and the network may only need to configure UE to report one set of the measurement result of beam index. Like in FIG. 9.

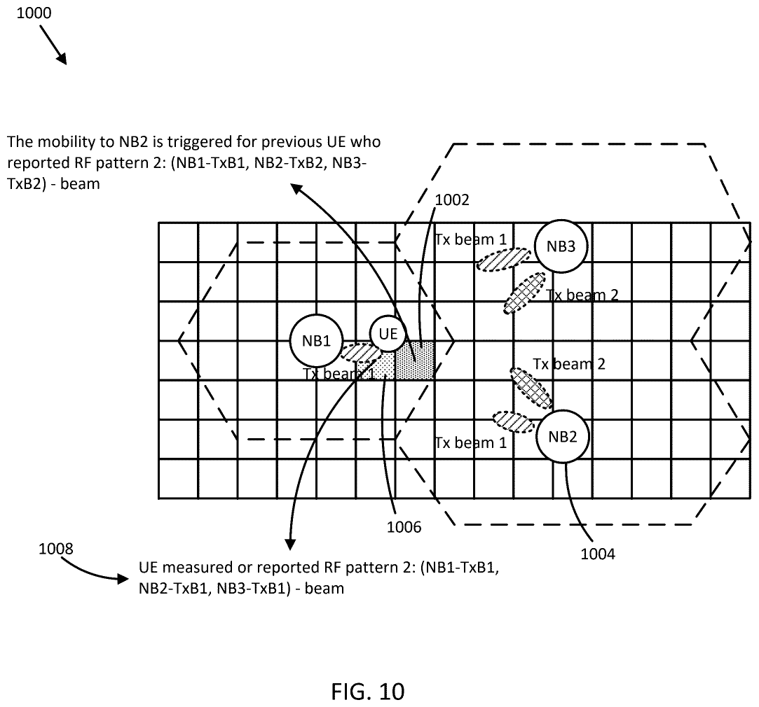

FIG. 10 illustrates another example fingerprint based measurement result prediction arrangement 1000 in accordance with some embodiments. The use case from network after UE reporting one pattern of the measurement metrics may include inter-frequency/intra-frequency/inter-RAT mobility. For the inter-frequency/intra-frequency/inter-RAT mobility, the NW may link the mobility decision with the fingerprint information in the database for previous UEs. In the arrangement 1000, a grid portion 1002 may trigger mobility to a second base station 1004 (NB2).

In a first alternative, the network may configure the UE to switch to the second base station 1004 as long as the measured fingerprint pattern matches a pattern which can trigger mobility based on previous UE's measurements. For example, for a UE measured RF pattern 2 as (NB1-TxB1, NB2-TxB2, NB3-TxB2) as in grid portion 1002, the UE may decide the mobility to the second base station 1004 directly (the NW pre-configures the mobility condition to UE), or the UE may report the measurement results to NW and the NW may decide the mobility to the second base station 1004 (NW decides the mobility by matching the finger print).

The NW may link the mobility decision with the fingerprint information in the database for previous UEs. For example, the grid portion 1002 may trigger mobility to the second base station. However, a second grid portion 1006 (adjacent to the grid portion 1002) may be a pre-alarm finger print to trigger UE or NW to prepare for the future possible mobility.

In a second alternative, the network may configure the UE to trigger the target cell measurement or trigger the target cell measurement report as long as the measured fingerprint pattern matches pattern which is adjacent to the fingerprint for mobility. For example, the UE may have measured RF pattern 2 as (NB1-TxB1, NB2-TxB1, NB3-TxB1), as shown in report 1008, when in the second grid portion 1006. The UE may start to measure or report the target second base station's 1004 signal strength to the NW for mobility preparation based on the measured RF pattern 2 values.

The approach to maintain the RF fingerprint database may include MDT based UE reporting in the coverage. The network may configure such reporting for the UE that support this MDT features, and these UEs may report the full set of the fingerprint patterns to NW. For example, the UEs may report signal strength (RF pattern 1), RTD (RF pattern 3), and beam information (RF pattern 2) for multiple carriers. The NW can collect such fingerprints from multiple MDT UEs at different locations for different times (morning or afternoon, weekday or weekend). MDT measurements are always reported with location information.

When UE has carrier aggregation (CA)/dual connectivity (DC) or intra-Frequency/inter-Frequency/inter-RAT measurement results, the UE may report these results to the NW. For those UEs that may not support MDT, the network may configure the UE to report limited number of CA/DC or intra-Frequency/inter-Frequency/inter-RAT measurement results, as same as the legacy mobility measurement configurations. The NW can collect such fingerprints from multiple UEs at different locations for different times (morning or afternoon, weekday or weekend). Such reporting can be with or without location information (optional).

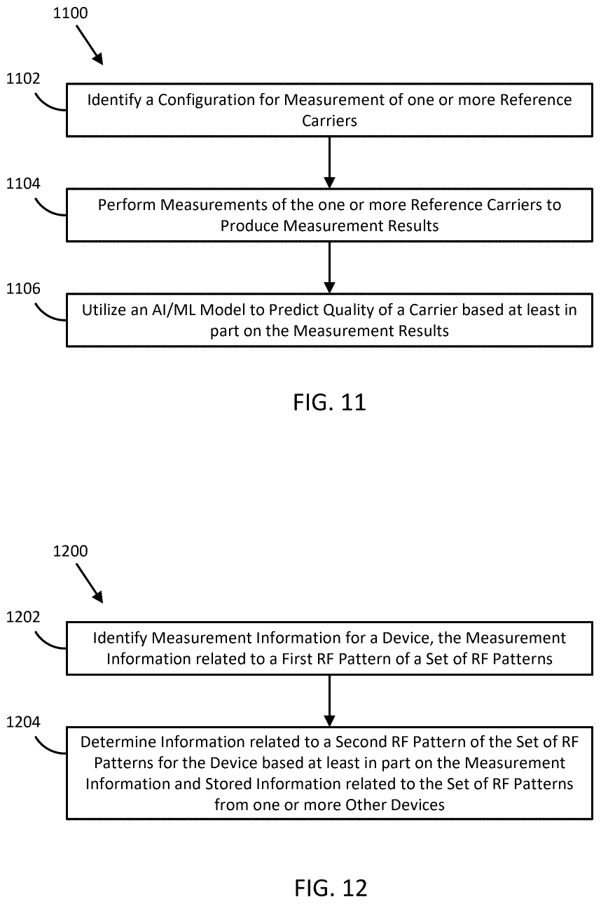

FIG. 11 illustrates an example procedure 1100 for predicting a quality of a carrier in accordance with some embodiments. The procedure 1100 may be performed by a UE, such as the UE 104 (FIG. 1), the UE 106 (FIG. 1), and/or the UE 200 (FIG. 2).

The procedure 1100 may include identifying a configuration for measurement of one or more reference carriers in 1102.

The procedure 1100 may include performing measurements of the one or more reference carriers to produce measurement results in 1104. In some embodiments, the measurements may comprise radio resource management (RRM) measurements.

The procedure 1100 may include utilizing an artificial intelligence (AI)/machine learning (ML) model to predict quality of a carrier based at least in part on the measurement results in 1106. In some embodiments, the carrier may may have a same cell coverage as the one or more reference carriers.

The procedure 1100 may further include identifying beam information for one or more different network elements in some embodiments. The AI/ML model may utilize the beam information to predict the quality of the carrier. In some of these embodiments, the beam information may include codebook information for the one or more reference carriers and the carrier.

In some embodiments, the procedure 1100 may further include identifying collocation information for the carrier. In these embodiments, the procedure 1100 may further include determining the AI/ML model from one or more AI/ML models for one or more carriers based at least in part on the collocation information.

In some embodiments, the procedure 1100 may further include determining one or more frequency division (FD) separations between the one or more reference carriers and the carrier. The AI/ML model may utilize the one or more FD separations to predict the quality of the carrier.

Any one or more of the operations in FIG. 11 may be performed in a different order than shown and/or one or more of the operations may be performed concurrently in embodiments. Further, it should be understood that one or more of the operations may be omitted from and/or one or more additional operations may be added to the procedure 1100 in other embodiments.

FIG. 12 illustrates an example procedure 1200 for determining additional RF pattern information of a set of RF patterns in accordance with some embodiments. The procedure 1200 may be performed by a base station, such as the base station 108 (FIG. 1) and/or the network device 300 (FIG. 3).

The procedure 1200 may include identifying measurement information for a device in 1202. The measurement information may be related to a first radio frequency (RF) pattern of a set of RF patterns.

In some embodiments, the procedure 1200 may further include configuring the device to limit performance of measurements for the set of RF patterns to first measurements corresponding to the first RF pattern. Further, the procedure 1200 may include configuring the device to perform target cell measurement or generate a target cell measurement report based at least in part on the measurement information matching a pattern adjacent to a fingerprint for mobility in some embodiments.

In some embodiments, the one or more other devices may support minimum drive test (MDT) features. In some of the embodiments, the procedure 1200 may further include configuring the one or more other devices to report MDT measurements for all RF patterns of the set of RF patterns.

The procedure 1200 may include determining information related to a second RF pattern of the set of RF patterns for the device based at least in part on the measurement information and stored information related to the set of RF patterns from one or more other devices in 1204.

In some embodiments, the measurement information may be first measurement information. In these embodiments, determining the information related to the second RF pattern for the device may include determining that the first measurement information matches second measurement information for the one or more other devices, the second measurement information related to the first RF pattern. Determining the information related to the second RF pattern for the device may further include determining third measurement information for the one or more other devices corresponding to the second measurement information, the third measurement information related to the second RF pattern. Further, Determining the information related to the second RF pattern for the device may include determining the information for the device to be equal to the third measurement information.

In some embodiments, the procedure 1200 may further include determining whether to perform secondary cell (SCell) addition or activation for the device based at least in part on the measurement information and the information for the device.

In some embodiments, the procedure 1200 may further include determining whether to perform primary secondary cell (PSCell) addition or activation for the device based at least in part on the measurement information and the information for the device.

In some embodiments, the procedure 1200 may further include determining whether to initiate a handover, cell reselection, or PSCell change for the device from a first base station to a second base station based at least in part on the measurement information and the information for the device.

In some embodiments, the procedure 1200 may further include configuring the device to determine whether to initiate a handover or cell reselection from a first base station to a second base station based at least in part on the measurement information.

Any one or more of the operations in FIG. 12 may be performed in a different order than shown and/or one or more of the operations may be performed concurrently in embodiments. Further, it should be understood that one or more of the operations may be omitted from and/or one or more additional operations may be added to the procedure 1200 in other embodiments.

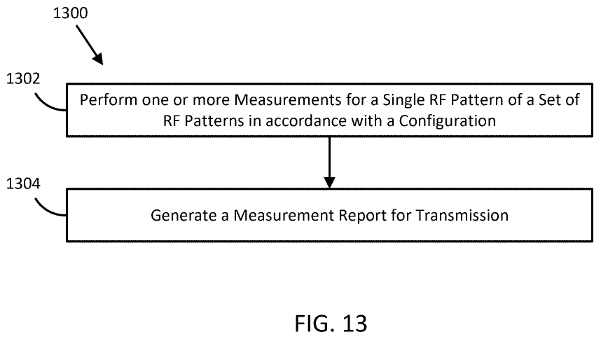

FIG. 13 illustrates an example procedure 1300 for performing measurements of a single RF pattern of a set of RF patterns in accordance with some embodiments. The procedure 1300 may be performed by a UE, such as the UE 104 (FIG. 1), the UE 106 (FIG. 1), and/or the UE 200 (FIG. 2).

The procedure 1300 may include performing one or more measurements for a single radio frequency (RF) pattern of a set of RF patterns in accordance with a configuration in 1302.

The procedure 1300 may include generating a measurement report for transmission, the measurement report including measurement information associated with the one or more measurements for the single RF pattern in 1304.

In some embodiments, the configuration may include a mobility condition. In these embodiments, the procedure 1300 may further include determining whether the measurement information fulfills the mobility condition. Further, the procedure 1300 may include determining whether to initiate a handover operation based at least in part on whether the measurement information fulfills the mobility condition.

In some embodiments, the procedure 1300 may include determining that the measurement information matches a pattern adjacent to a fingerprint for mobility. Further, the procedure 1300 may include initiating target cell measurement based at least in part on the determination that the measurement information matches the pattern.

In some embodiments, the procedure 1300 may include determining that the measurement information matches a pattern adjacent to a fingerprint for mobility. Further, the procedure 1300 may include generating a target cell measurement report for transmission based at least in part on the determination that the measurement information matches the pattern.

Any one or more of the operations in FIG. 13 may be performed in a different order than shown and/or one or more of the operations may be performed concurrently in embodiments. Further, it should be understood that one or more of the operations may be omitted from and/or one or more additional operations may be added to the procedure 1300 in other embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 may include a method comprising identifying a configuration for measurement of one or more reference carriers, performing measurements of the one or more reference carriers to produce measurement results, and utilizing an artificial intelligence (AI)/machine learning (ML) model to predict quality of a carrier based at least in part on the measurement results.

Example 2 may include the method of example 1, wherein the carrier has a same cell coverage as the one or more reference carriers.

Example 3 may include the method of example 1, wherein the measurements comprise radio resource management (RRM) measurements.

Example 4 may include the method of example 1, further comprising identifying beam information for one or more different network elements, wherein the AI/ML model utilizes the beam information to predict the quality of the carrier.

Example 5 may include the method of example 4, wherein the beam information includes codebook information for the one or more reference carriers and the carrier.

Example 6 may include the method of example 1, further comprising identifying collocation information for the carrier, and determining the AI/ML model from one or more AI/ML models for one or more carriers based at least in part on the collocation information.

Example 7 may include the method of example 1, further comprising determining one or more frequency division (FD) separations between the one or more reference carriers and the carrier, wherein the AI/ML model utilizes the one or more FD separations to predict the quality of the carrier.

Example 8 may include a method comprising identifying measurement information for a device, the measurement information related to a first radio frequency (RF) pattern of a set of RF patterns, and determining information related to a second RF pattern of the set of RF patterns for the device based at least in part on the measurement information and stored information related to the set of RF patterns from one or more other devices.

Example 9 may include the method of example 8, wherein the measurement information is first measurement information, and wherein determining the information related to the second RF pattern for the device includes determining that the first measurement information matches second measurement information for the one or more other devices, the second measurement information related to the first RF pattern, determining third measurement information for the one or more other devices corresponding to the second measurement information, the third measurement information related to the second RF pattern, and determining the information for the device to be equal to the third measurement information.

Example 10 may include the method of example 8, further comprising configuring the device to limit performance of measurements for the set of RF patterns to first measurements corresponding to the first RF pattern.

Example 11 may include the method of example 8, further comprising determining whether to perform secondary cell (SCell) addition or activation for the device based at least in part on the measurement information and the information for the device.

Example 12 may include the method of example 8, further comprising determining whether to perform primary secondary cell (PSCell) addition or activation for the device based at least in part on the measurement information and the information for the device.

Example 13 may include the method of example 8, further comprising determining whether to initiate a handover, cell reselection, or primary secondary cell change (PSCell) for the device from a first base station to a second base station based at least in part on the measurement information and the information for the device.

Example 14 may include the method of example 8, further comprising configuring the device to determine whether to initiate a handover or cell reselection from a first base station to a second base station based at least in part on the measurement information.

Example 15 may include the method of example 8, further comprising configuring the device to perform target cell measurement or generate a target cell measurement report based at least in part on the measurement information matching a pattern adjacent to a fingerprint for mobility.

Example 16 may include the method of example 8, wherein the one or more other devices support minimum drive test (MDT) features, and wherein the method further comprises configuring the one or more other devices to report MDT measurements for all RF patterns of the set of RF patterns.

Example 17 may include a method comprising performing one or more measurements for a single radio frequency (RF) pattern of a set of RF patterns in accordance with a configuration, and generating a measurement report for transmission, the measurement report including measurement information associated with the one or more measurements for the single RF pattern.

Example 18 may include the method of example 17, wherein the configuration includes a mobility condition, and wherein the method further comprises determining whether the measurement information fulfills the mobility condition, and determining whether to initiate a handover operation based at least in part on whether the measurement information fulfills the mobility condition.

Example 19 may include the method of example 17, further comprising determining that the measurement information matches a pattern adjacent to a fingerprint for mobility, and initiating target cell measurement based at least in part on the determination that the measurement information matches the pattern.

Example 20 may include the method of example 17, further comprising determining that the measurement information matches a pattern adjacent to a fingerprint for mobility, and generating a target cell measurement report for transmission based at least in part on the determination that the measurement information matches the pattern.

Example 21 may include an apparatus comprising means to perform one or more elements of a method described in or related to any of examples 1-20, or any other method or process described herein.

Example 22 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 23 may include an apparatus comprising logic, modules, or circuitry to perform one or more elements of a method described in or related to any of examples 1-20, or any other method or process described herein.

Example 24 may include a method, technique, or process as described in or related to any of examples 1-20, or portions or parts thereof.

Example 25 may include an apparatus comprising: one or more processors and one or more computer-readable media comprising instructions that, when executed by the one or more processors, cause the one or more processors to perform the method, techniques, or process as described in or related to any of examples 1-20, or portions thereof.

Example 26 may include a signal as described in or related to any of examples 1-20, or portions or parts thereof.

Example 27 may include a datagram, information element, packet, frame, segment, PDU, or message as described in or related to any of examples 1-20, or portions or parts thereof, or otherwise described in the present disclosure.

Example 28 may include a signal encoded with data as described in or related to any of examples 1-20, or portions or parts thereof, or otherwise described in the present disclosure.

Example 29 may include a signal encoded with a datagram, IE, packet, frame, segment, PDU, or message as described in or related to any of examples 1-20, or portions or parts thereof, or otherwise described in the present disclosure.

Example 30 may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Example 31 may include a computer program comprising instructions, wherein execution of the program by a processing element is to cause the processing element to carry out the method, techniques, or process as described in or related to any of examples 1-20, or portions thereof.

Example 32 may include a signal in a wireless network as shown and described herein.

Example 33 may include a method of communicating in a wireless network as shown and described herein.

Example 34 may include a system for providing wireless communication as shown and described herein.

Example 35 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
identifying a configuration for measurement of at least one reference carrier;
performing measurements of the at least one reference carrier to produce measurement results; and
utilizing an artificial intelligence (AI) or machine learning (ML) model to predict quality of a carrier based at least in part on the measurement results.

2. The method of claim 1, wherein the carrier has a same cell coverage as the at least one reference carrier.

3. The method of claim 1, wherein the measurements comprise radio resource management (RRM) measurements.

4. The method of claim 1, further comprising:
identifying beam information for at least one different network element, wherein the AI or ML model utilizes the beam information to predict the quality of the carrier.

5. The method of claim 4, wherein the beam information includes codebook information for the at least one reference carrier and the carrier.

6. The method of claim 1, further comprising:
identifying collocation information for the carrier; and
determining the AI or ML model from at least one AI or ML model for the at least one reference carrier based at least in part on the collocation information.

7. The method of claim 1, further comprising:
determining at least one frequency division (FD) separation between the at least one reference carrier and the carrier, wherein the AI or ML model utilizes the at least one FD separation to predict the quality of the carrier.

8. A method comprising:
identifying measurement information for a device, the measurement information related to a first radio frequency (RF) pattern of a set of RF patterns; and
determining information related to a second RF pattern of the set of RF patterns for the device based at least in part on the measurement information and stored information related to the set of RF patterns from at least one other device.

9. The method of claim 8, wherein the measurement information is first measurement information, and wherein determining the information related to the second RF pattern for the device includes:
determining that the first measurement information matches second measurement information for the at least one other device, the second measurement information related to the first RF pattern;
determining third measurement information for the at least one other device corresponding to the second measurement information, the third measurement information related to the second RF pattern; and
determining the information for the device to be equal to the third measurement information.

10. The method of claim 8, further comprising configuring the device to limit performance of measurements for the set of RF patterns to first measurements corresponding to the first RF pattern.

11. The method of claim 8, further comprising determining whether to perform secondary cell (SCell) addition or activation for the device based at least in part on the measurement information and the information for the device.

12. The method of claim 8, further comprising determining whether to perform primary secondary cell (PSCell) addition or activation for the device based at least in part on the measurement information and the information for the device.

13. The method of claim 8, further comprising:
determining whether to initiate a handover, cell reselection, or primary secondary cell (PSCell) change for the device from a first base station to a second base station based at least in part on the measurement information and the information for the device.

14. The method of claim 8, further comprising:
configuring the device to determine whether to initiate a handover or cell reselection from a first base station to a second base station based at least in part on the measurement information.

15. The method of claim 8, further comprising:
configuring the device to perform target cell measurement or generate a target cell measurement report based at least in part on the measurement information matching a pattern adjacent to a fingerprint for mobility.

16. The method of claim 8, wherein the at least one other device supports minimum drive test (MDT) features, and wherein the method further comprises:
configuring the at least one other device to report MDT measurements for all RF patterns of the set of RF patterns.

17. An apparatus comprising:
processing circuitry to:
perform at least one measurement for a single radio frequency (RF) pattern of a set of RF patterns in accordance with a configuration; and
generate a measurement report for transmission, the measurement report including measurement information associated with the at least one measurement for the single RF pattern; and
interface circuitry coupled with the processing circuitry, the interface circuitry to enable communication.

18. The apparatus of claim 17, wherein the configuration includes a mobility condition, and wherein the processing circuitry is further to:
determine whether the measurement information fulfills the mobility condition; and
determine whether to initiate a handover operation based at least in part on whether the measurement information fulfills the mobility condition.

19. The apparatus of claim 17, wherein the processing circuitry is further to:
determine that the measurement information matches a pattern adjacent to a fingerprint for mobility; and
initiate target cell measurement based at least in part on the determination that the measurement information matches the pattern.

20. The apparatus of claim 17, wherein the processing circuitry is further to:
determine that the measurement information matches a pattern adjacent to a fingerprint for mobility; and
generate a target cell measurement report for transmission based at least in part on the determination that the measurement information matches the pattern.
